(19) United States
(12) Patent Application Publication
(10) Pub. No.: US 2019/0385176 A1
(43) Pub. Date: Dec. 19, 2019

(54) INFORMATION PROCESSING APPARATUS, INFORMATION PROCESSING METHOD, AND INFORMATION PROCESSING PROGRAM

(71) Applicant: NEC CORPORATION, Tokyo (JP)

(72) Inventors: Yutaka KINOSHITA, Tokyo (JP); Shunsuke ISHII, Tokyo (JP)

(73) Assignee: NEC CORPORATION, Tokyo (JP)

(21) Appl. No.: 16/470,022

(22) PCT Filed: Oct. 19, 2017
(86) PCT No.: PCT/JP2017/037800

§ 371 Date: Jun. 14, 2019

(30) Foreign Application Priority Data
Dec. 15, 2016 (JP) 2016-243723

(51) Int. Cl. G06Q 30/02; G06K 9/00

(52) U.S. Cl. CPC G06Q 30/0201; G06K 9/00771; G06Q 30/0224; G06Q 30/0252; G06Q 30/0269

(57) ABSTRACT

An effective service is decided for a store visitor. There is provided an information processing apparatus including a store visitor information generator and a service decider. The store visitor information generator generates store visitor information of a store visitor who visits a store by analyzing a video acquired from at least one image capturer that captures an outside of the store. The service decider decides, based on the store visitor information generated by the store visitor information generator, a service to be provided to the store visitor.

### CROSS REFERENCE TO RELATED APPLICATIONS

This application is based upon and claims the benefit of priority from Japanese patent application No. 2016-243723, filed on Dec. 15, 2016, the disclosure of which is incorporated herein in its entirety by reference.

### TECHNICAL FIELD

The present invention relates to an information processing apparatus, an information processing method, and an information processing program.

### BACKGROUND ART

In the above technical field, patent literature 1 discloses a technique of transmitting, in a vehicle sharing service (car sharing), an electronic coupon closely related to a parking position based on the parking position of a service target vehicle (shared car) and ON/OFF of an engine (paragraphs [0043], [0070], and [0081], and the like). Patent literature 2 discloses a technique of automatically authenticating the vehicle number of a vehicle entering the parking lot of a store, and providing a service matching a customer appearing in a vehicle from a display to the customer based on the automatically authenticated vehicle number (paragraphs and [0019], and the like). Patent literature 3 discloses a technique of receiving a key signal from a wireless key device, and displaying an image for notifying a clerk of a restaurant that a customer visits the restaurant (paragraph [0036], [0051], and [0052], and the like). Patent literature 4 discloses a technique of detecting an automobile entering the parking lot of a restaurant using an infrared sensor provided in the entrance gate of the parking lot, and sending a signal to a display panel when the number of automobiles having passed through the entrance gate within a preset time becomes equal to or more than a predetermined number (paragraph [0019] and the like). Furthermore, patent literature 5 discloses a technique of recording, as store visit situation data of a customer, a date/time when the point card of the customer is loaded to a coupon ticket issuance machine, and totalizing the customers for each store visit count per month, thereby managing the customer trend (claim 1, paragraphs [0011] and [0037], and the like).

### CITATION LIST

### Patent Literature

Patent literature 1: Japanese Patent Laid-Open No. 2016-045949

Patent literature 2: Japanese Patent Laid-Open No. 2011-103079

Patent literature 3: Japanese Patent Laid-Open No. 2009-059282

Patent literature 4: Japanese Patent Laid-Open No. 2001-331833

Patent literature 5: Japanese Patent Laid-Open No. 2000-076552

### SUMMARY OF THE INVENTION

### Technical Problem

In the techniques described in patent literatures 1 to 5 described above, however, it is impossible to provide an effective service to a store visitor.

The present invention enables to provide a technique of solving the above-described problem.

### Solution to Problem

One example aspect of the present invention provides an information processing apparatus comprising:

a store visitor information generator that generates store visitor information of a store visitor who visits a store by analyzing a video acquired from at least one image capturer that captures an outside of the store; and

a service decider that decides, based on the store visitor information generated by the store visitor information generator, a service to be provided to the store visitor.

Another example aspect of the present invention provides an information processing method comprising:

generating store visitor information of a store visitor who visits a store by analyzing a video acquired from at least one image capturer that captures an outside of the store; and

deciding, based on the store visitor information generated in the generating, a service to be provided to the store visitor.

Still other example aspect of the present invention provides an information storage medium for causing a computer to execute a method, comprising:

generating store visitor information of a store visitor who visits a store by analyzing a video acquired from at least one image capturer that captures an outside of the store; and

deciding, based on the store visitor information generated in the generating, a service to be provided to the store visitor.

### Advantageous Effects of Invention

According to the present invention, it is possible to provide an effective service to a store visitor.

### BRIEF DESCRIPTION OF DRAWINGS

FIG. 1 is a block diagram showing the arrangement of an information processing apparatus according to the first example embodiment of the present invention;

FIG. 2 is a view for explaining an overview of the operation of an information processing apparatus according to the second example embodiment of the present invention;

FIG. 3 is a block diagram showing the arrangement of the information processing apparatus according to the second example embodiment of the present invention;

FIG. 4A is a table showing an example of a provided service table included in the information processing apparatus according to the second example embodiment of the present invention;

FIG. 4B is a table showing another example of the provided service table included in the information processing apparatus according to the second example embodiment of the present invention;

FIG. 4C is a table showing an example of a store visitor information table included in the information processing apparatus according to the second example embodiment of the present invention;

FIG. 5 is a block diagram showing the hardware arrangement of the information processing apparatus according to the second example embodiment of the present invention;

FIG. 6 is a flowchart for explaining the processing procedure of the information processing apparatus according to the second example embodiment of the present invention;

FIG. 7 is a block diagram showing the arrangement of an information processing apparatus according to the third example embodiment of the present invention;

FIG. 8 is a table showing an example of an owner information table included in the information processing apparatus according to the third example embodiment of the present invention;

FIG. 9 is a block diagram showing the hardware arrangement of the information processing apparatus according to the third example embodiment of the present invention;

FIG. 10 is a flowchart for explaining the processing procedure of the information processing apparatus according to the third example embodiment of the present invention;

FIG. 11 is a block diagram showing the arrangement of an information processing apparatus according to the fourth example embodiment of the present invention; and

FIG. 12 is a table showing an example of a timing information table included in the information processing apparatus according to the fourth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

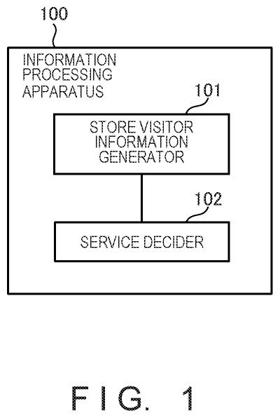

An information processing apparatus 100 according to the first example embodiment of the present invention will be described with reference to FIG. 1. The information processing apparatus 100 is an apparatus that generates store visitor information of a store visitor, and decides, based on the generated store visitor information, a service to be provided to the store visitor.

As shown in FIG. 1, the information processing apparatus 100 includes a store visitor information generator 101 and a service decider 102. The store visitor information generator 101 generates store visitor information of a store visitor who visits a store by analyzing a video acquired from at least one image capturer that captures the outside of the store. Based on the store visitor information generated by the store visitor information generator 101, the service decider 102 decides a service to be provided to the store visitor.

According to this example embodiment, since a provided service is decided in accordance with generated store visitor information, it is possible to provide an effective service to a store visitor.

### Second Example Embodiment

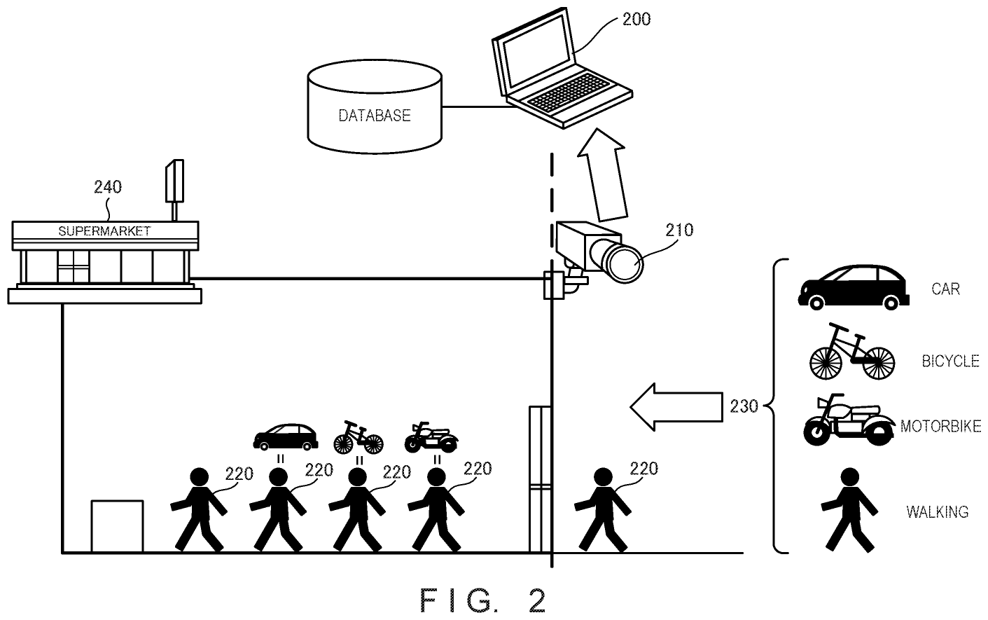

An information processing apparatus according to the second example embodiment of the present invention will be described next with reference to FIGS. 2 to 6. FIG. 2 is a view for explaining an overview of the operation of an information processing apparatus 200 according to this example embodiment.

An outside-the-store camera 210 is a camera that captures a video of the outside of a store 240, and captures, for example, a parking lot established together with the store 240, a road as a traffic line to the entrance of the store 240, and the like. Then, the information processing apparatus 200 acquires the video of the outside of the store 240, that has been captured by the outside-the-store camera 210. Note that one outside-the-store camera 210 or a plurality of outside-the-store cameras 210 may be provided.

The information processing apparatus 200 analyzes store visitor information such as a store transporter 230 of a store visitor 220 by, for example, extracting the store visitor 220 to the store 240 from the acquired video. Examples of the store transporter 230 are an automobile (car), a bicycle, a motorcycle (motorbike), walking, a taxi, a fixed-route bus, and a train.

The information processing apparatus 200 decides a service to be provided to the store visitor 220 in accordance with the analyzed store transporter 230 of the store visitor 220. If the store visitor 220 visits the store by, for example, car, the information processing apparatus 200 may issue, as a service, a discount coupon for car accessories. If the car as the store transporter 230 is dirty, a coupon may be issued as a service to lead to a car washing machine in a gas station established together with the store. Furthermore, for example, if owner information of the car is acquired from a car number, a VIP (Very Important Person) customer is specified from the acquired owner information, and a clerk can be prompted to be prepared to wait on the customer before the store visitor 220 as the VIP customer enters the store. For example, if the store visitor 220 visits the store by taxi, the information processing apparatus 200 may issue a taxi coupon as a service. If the store visitor 220 visits store by fixed-route bus, the information processing apparatus 200 may issue a bus ticket or a book of bus tickets as a service.

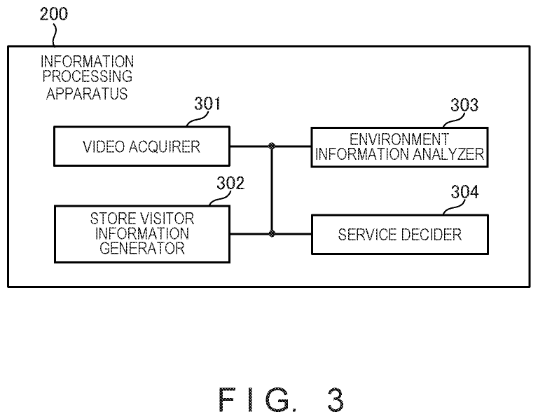

FIG. 3 is a block diagram showing the arrangement of the information processing apparatus 200 according to this example embodiment. The information processing apparatus 200 includes a video acquirer 301, a store visitor information generator 302, an environment information analyzer 303, and a service decider 304.

The video acquirer 301 acquires a video captured by the outside-the-store camera 210 that captures the outside of the store 240. The video acquirer 301 may acquire a video from one outside-the-store camera 210 or videos from a plurality of outside-the-store cameras 210. The outside-the-store camera 210 may have the function of an infrared camera, a thermography camera, or the like, or an infrared camera or a thermography camera may be installed as the outside-the-store camera 210.

The store visitor information generator 302 analyzes store visitor information by, for example, extracting the store visitor 220 to the store 240 from the acquired video. The store visitor information generator 302 analyzes, as store visitor information, at least one of the store transporter 230 of the store visitor 220, pre/post-visit behavior information, and store visit member information. The store visitor information generator 302 generates store visitor information by analyzing attribute information of the store visitor 220.

For example, the store visitor information generator 302 analyzes, from the video captured by the outside-the-store camera 210, the means (store transporter) used by the store visitor 220 to visit the store 240. The store transporter 230 is related to the store visit method of the store visitor 220 to the store 240, and is, for example, an automobile, a motorcycle, a bicycle, walking, a taxi, a fixed-route bus, or a train.

In addition, the store visitor information generator 302 analyzes, from the video captured by the outside-the-store camera 210, pre/post-visit behavior information indicating behaviors before and after the store visitor 220 visits the store 240. The pre/post-visit behavior information is information indicating, for example, that the store visitor 220 to the store 240 directly goes to the entrance of the store 240 to enter the store, or that the store visitor 220 purchases something from a vending machine in the parking space of the store 240, and then goes to the entrance of the store 240 to enter the store. That is, the pre/post-visit behavior information is information about a behavior until the store visitor 220 enters the store 240 from its entrance and a behavior during a period from when the store visitor 220 exits from the entrance of the store 240 to the outside of the store 240 until he/she goes out of the image capturing range of the outside-the-store camera 210.

Furthermore, the store visitor information generator 302 analyzes, from the video captured by the outside-the-store camera 210, the store visit member information about the number of members as the store visitors 220 to the store 240 or the like. The store visit member information is information indicating, for example, whether the store visitor 220 visits the store alone or with other people. If the store visitor 220 visits the store with other people, the store visit member information is information about the number of visit members, the male-to-female ratio, the number of adults, the number of children, and the like.

Furthermore, the store visitor information generator 302 analyzes, from the video captured by the outside-the-store camera 210, the attribute information of the store visitor 220 as the store visitor information. The attribute information includes the age, sex, and physique of the store visitor 220. The present invention, however, is not limited to them. The attribute information may include, for example, the clothing of the store visitor 220, the presence/absence of glasses, the shape of the glasses, a hairstyle, the size of shoes, the color of the shoes, and ornaments.

The environment information analyzer 303 analyzes, from, for example, the video captured by the outside-the-store camera 210, environment information around the store when the store visitor 220 visits the store 240. The environment information includes, for example, the weather, a temperature, and an event held around the store. The present invention, however, is not limited to them. In this case, for example, the environment information analyzer 303 may analyze the environment information in consideration of information obtained from a store manager and information obtained from the Web in addition to the video captured by the outside-the-store camera 210. The present invention, however, is not limited to them. In addition to analysis of the environment information from the video, the environment information analyzer 303 may acquire, for example, environment information around the store 240 by communication. That is, the environment information analyzer 303 may acquire environment information from an environment information distribution site or the like.

In accordance with the analysis result of the store visitor information generator 302, the service decider 304 decides a service to be provided to the store visitor 220. That is, in accordance with the store visitor information and the attribute information analyzed by the store visitor information generator 302, the service decider 304 decides a service to be provided to the store visitor 220. Furthermore, in accordance with the analysis result of the environment information analyzer 303, the service decider 304 decides a service to be provided to the store visitor 220. That is, in consideration of the attribute information and the environment information in addition to the store visitor information, the service decider 304 decides a service to be provided to the store visitor 220.

Examples of the service to be provided to the store visitor 220 are a service to be used by the store visitor 220 while he/she visits the store 240, a service for prompting the store visitor 220 to visit the store again, and a service for promoting the store visit, to the store 240, of a customer other than the store visitor. The service to be used by the store visitor 220 while he/she visits the store is, for example, issuance of a discount coupon for a specific product. The service for prompting the store visitor 220 to visit the store again is, for example, issuance of a coupon usable at the time of the next store visit. Furthermore, the service for promoting the store visit, to the store 240, of a customer other than the store visitor is, for example, issuance of a discount coupon when the store visitor brings his/her friend to the store 240.

Other examples of the service to be provided to the store visitor 220 are a service for changing an assortment of the store 240, a service for replenishing hot-selling products, and a service for issuing a discount coupon for a new product. For example, the information processing apparatus 200 may present information representing the decided service to at least one of the store visitor 220, the operator of the store 240, and the manager of the store 240. More specifically, as an example, the information processing apparatus 200 may display information representing a coupon on the display unit (not shown) of a customer service terminal or a POS (Point of Sale), or print out the information. As described above, the information processing apparatus 200 can present the information representing the decided service to a target to be presented, by various methods in addition to the display method and printout method exemplified above.

The information processing apparatus 200 may extract a store visitor video from the video captured by the outside-the-store camera 210, and store the extracted store visitor video and the store visitor information in association with each other. The store visitor information generator 302 may generate store visitor information from the stored store visitor video and store visitor information.

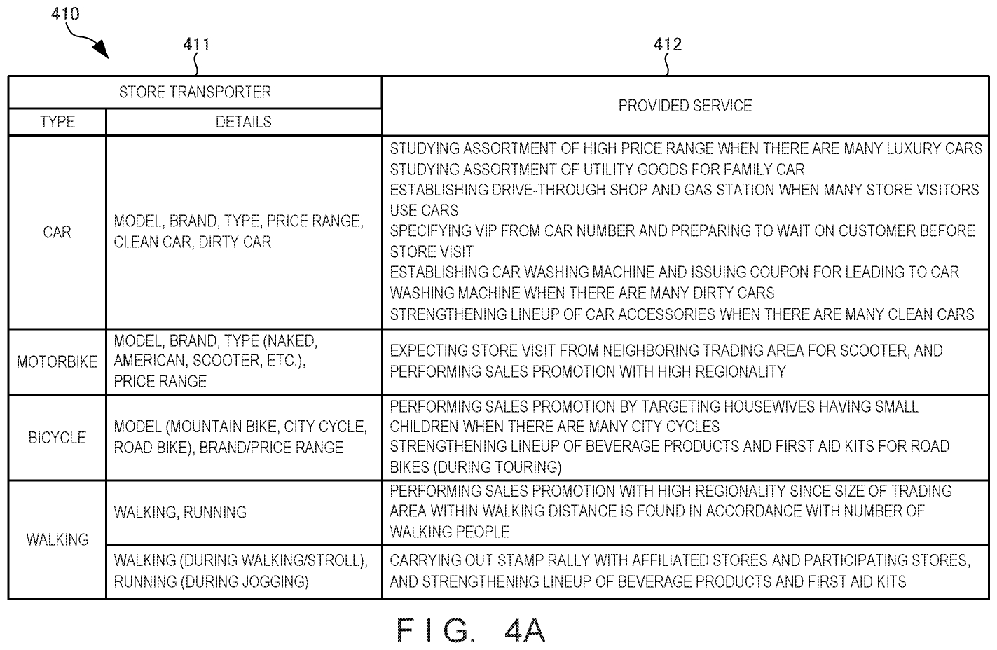

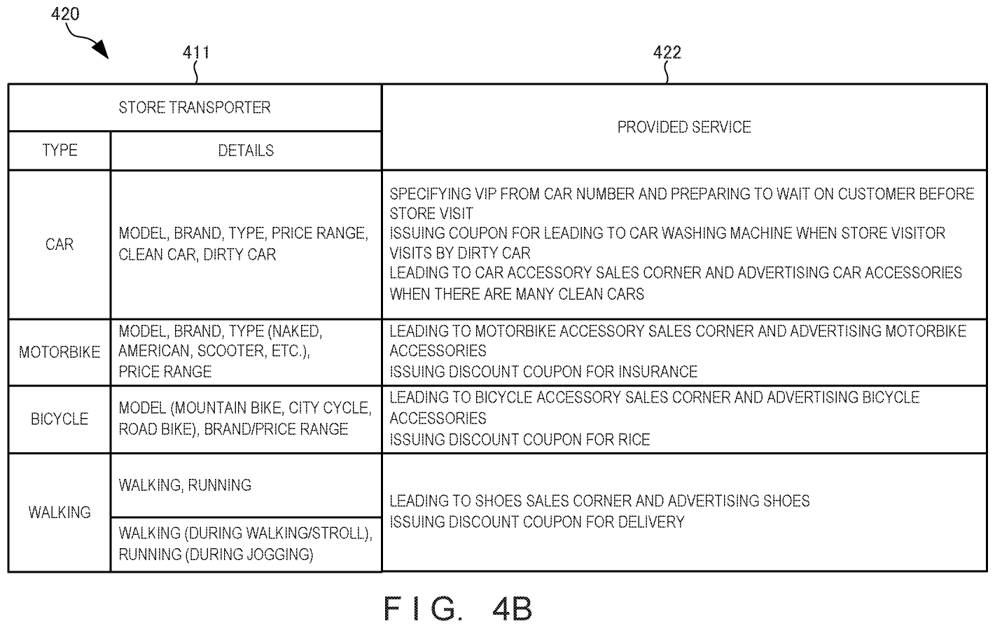

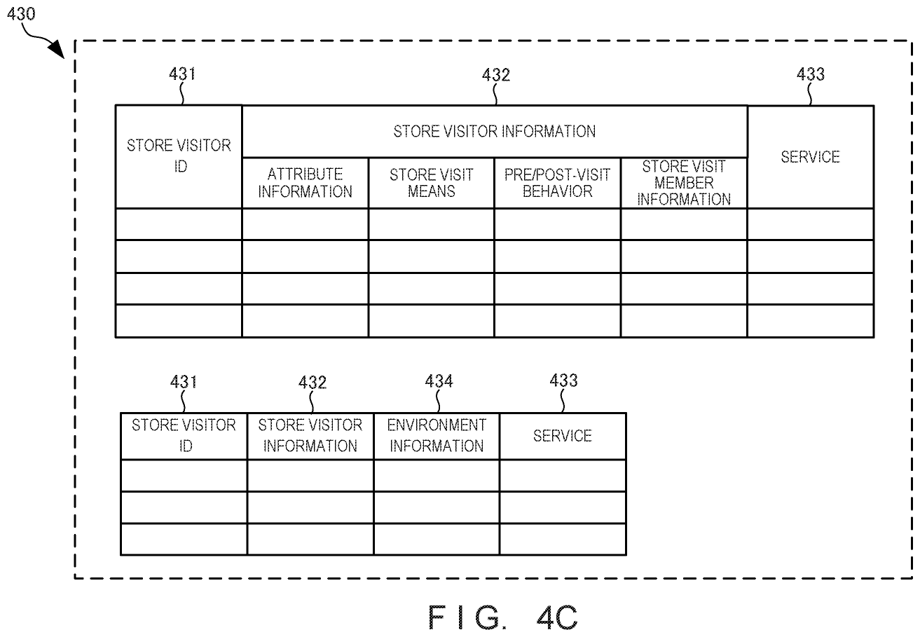

FIG. 4A is a table showing an example of a provided service table 410 included in the information processing apparatus 200 according to this example embodiment. The provided service table 410 stores a provided service 412 in association with a store transporter 411. The store transporter 411 is information indicating the method by which the store visitor 220 to the store has come to the store. The store transporter 411 stores the type and details of the method. Examples of the type of the store transporter 411 are an automobile (car), a motorcycle (motorbike), a bicycle, and walking.

When the type of the store transporter 411 is a car, the details of the store transporter 411 correspond to detailed information of the store transporter 411 such as a model, brand, type, price range, clean car, dirty car, and manufacturer. Similarly, when the type of the store transporter 411 is a motorbike, the details of the store transporter 411 correspond to detailed information of the store transporter 411 such as a model, brand, type (naked, American, scooter, and the like), price range, and manufacturer. When the type of the store transporter 411 is a bicycle, the details of the store transporter 411 correspond to detailed information of the store transporter 411 such as a model (mountain bike, road bike, or city cycle), brand, price range, and manufacturer. Furthermore, when the type of the store transporter 411 is walking, the details of the store transporter 411 correspond to detailed information of the store transporter 411 such as waking (during walking or a stroll) or running (during jogging).

The provided service 412 is a service to be provided to the store visitor 220, and is decided in correspondence with the store transporter 411. If the store transporter 411 is a car, examples of the provided service 412 are “studying an assortment of a high price range when there are many luxury cars”, “studying an assortment of utility goods for a family car”, and “establishing a drive-through shop and a gas station when many store visitors use cars”. Further examples of the provided service 412 are “specifying a VIP customer from a car number and preparing to wait on the customer before a store visit”, and “establishing a car washing machine and issuing a coupon for leading to the car washing machine when there are many dirty cars”. There is also “strengthening the lineup of car accessories when there are many clean cars” as the provided service 412. The present invention, however, is not limited to them.

If the store transporter 411 is a motorbike, examples of the provided service 412 are “expecting a store visit from a neighboring trading area for a scooter, and performing sales promotion with high regionality”. The present invention, however, is not limited to this.

If the store transporter 411 is a bicycle, examples of the provided service 412 are “performing sales promotion by targeting housewives having small children when there are many city cycles”, and “strengthening the lineup of beverage products and first aid kits for road bikes (during touring)”. The present invention, however, is not limited to them.

If the store transporter 411 is walking, examples of the provided service 412 are “performing sales promotion with high regionality since the size of a trading area within the walking distance is found in accordance with the number of walking people”, and “carrying out a stamp rally with affiliated stores and participating stores, and strengthening the lineup of beverage products and first aid kits”. The present invention, however, is not limited to them.

The provided service table 410 is a table that stores, for example, services to be provided to the operator and manager of the store 240 in addition to the store visitor. Therefore, the information processing apparatus 200 decides a service to be provided to the store visitor or the operator or manager of the store 240 with reference to the provided service table 410.

FIG. 4B is a table showing another example of the provided service table included in the information processing apparatus 200 according to this example embodiment. A provided service table 420 stores a provided service 422 in associated with the store transporter 411. The provided service table 420 is a table that stores a service to a store visitor to the store 240. For example, if the store visitor means is a car, examples of the provided service 412 are “specifying a VIP from a car number, and preparing to wait on the customer before a store visit”, “issuing a coupon for leading to the car washing machine when the store visitor visits by a dirty car”, “leading to a car accessory sales corner and advertising car accessories when there are many clean cars”, and “issuing a discount coupon for furniture”. The present invention, however, is not limited to them.

If the store transporter 411 is a motorbike, examples of the provided service 412 are “leading to a motorbike accessory sales corner and advertising motorbike accessories” and “issuing a discount coupon for insurance”. The present invention, however, is not limited to them. If the store transporter 411 is a bicycle, examples of the provided service 412 are “leading to a bicycle accessory sales corner and advertising bicycle accessories” and “issuing a discount coupon for rice”. The present invention, however, is not limited to them. If the store transporter 411 is walking, examples of the provided service 412 are “leading to a shoes sales corner and advertising shoes” and “issuing a discount coupon for delivery”. The present invention, however, is not limited to them.

FIG. 4C is a table showing an example of a store visitor information table 430 included in the information processing apparatus 200 according to this example embodiment. A store visitor information table 430 is used to decide store visitor information 432 and a service 433 in association with a store visitor ID (IDentifier) 431. The store visitor information 432 includes attribute information, a store transporter, a pre/post-visit behavior, and store visit member information. Furthermore, the store visitor information table 430 stores environment information 434 in association with the store visitor ID 431. If the store visitor ID 431 and the store visitor information 432 are stored in advance in association with each other in this way, the information processing apparatus 200 can decide the service 433 with reference to the store visitor information table 430.

Note that, instead of the method of deciding the provided service 412 by the store transporter, a service to be provided to a store visitor may be decided in accordance with the attributes of the store visitor or the tendency of the attributes of the store visitor. Similarly, a service to be provided to a store visitor may be decided in accordance with the environment information, and a service to be provided to the operator of the store or the like other than a store visitor may be decided in accordance with the environment information.

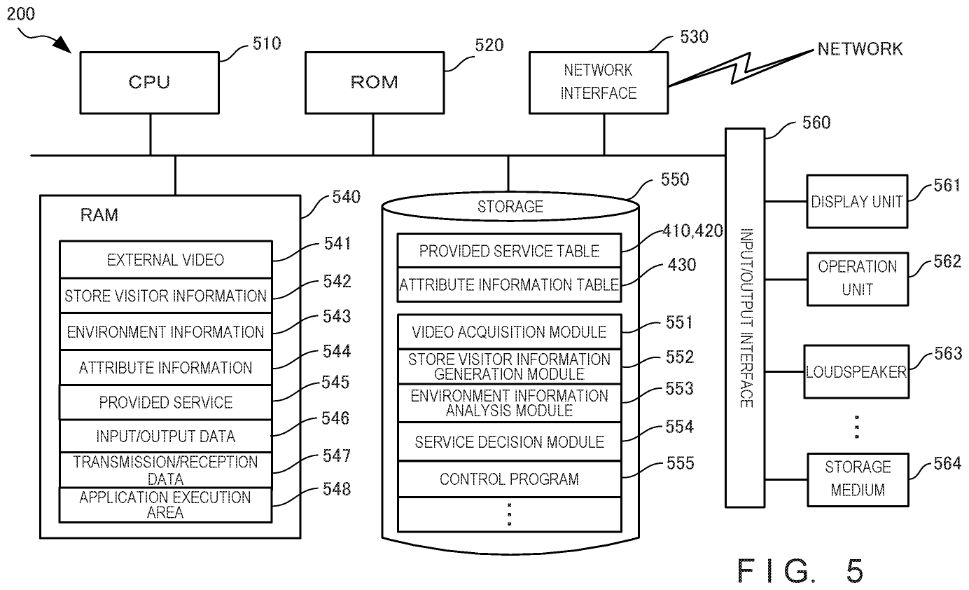

FIG. 5 is a block diagram showing the hardware arrangement of the information processing apparatus 200 according to this example embodiment. A CPU (Central Processing Unit) 510 is an arithmetic control processor, and implements the functional components of the information processing apparatus 200 shown in FIG. 3 by executing a program. A ROM (Read Only Memory) 520 stores permanent data such as initial data and a program, and other programs. A network interface 530 communicates with another apparatus or the like via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads transmission/reception data in or from the area of a RAM (Random Access Memory) 540. It is desirable to provide a DMAC (Direct Memory Access Controller) (not shown) for transferring data between the RAM 540 and a storage 550. An input/output interface 560 desirably includes a CPU independent of the CPU 510, and writes or reads input/output data in or from the area of the RAM 540. Therefore, the CPU 510 recognizes that data has been received by the RAM 540 or transferred to the RAM 540, and processes the data. The CPU 510 prepares a processing result in the RAM 540, and delegates succeeding transmission or transfer to the network interface 530, the DMAC, or the input/output interface 560.

The RAM 540 is a random access memory used as a temporary storage work area by the CPU 510. An area to store data necessary for implementation of the example embodiment is allocated to the RAM 540. An external video 541 is a video of the outside of the store 240, that has been captured by the outside-the-store camera 210, and acquired by the video acquirer 301. Store visitor information 542 is information including the store transporter 230 of the store visitor 220 and analyzed by the store visitor information generator 302. Environment information 543 is information about an environment around the store 240, that includes the weather when the store visitor 220 visits the store. Attribute information 544 is information about the attributes of the store visitor 220 such as the age, sex, and physique of the store visitor 220. A provided service 545 is a service decided in accordance with the store transporter 230 of the store visitor 220 or the like and provided to the store visitor 220. The provided service 545 is, for example, data deployed from the provided service table 410, 420.

Input/output data 546 is data input/output via the input/output interface 560. Transmission/reception data 547 is data transmitted/received via the network interface 530. The RAM 540 includes an application execution area 548 used to execute various application modules.

The storage 550 stores a database, various parameters, or the following data or programs necessary for implementation of this example embodiment. The storage 550 stores the provided service table 410 and the attribute information table 430. The provided service table 410 is the table, shown in FIG. 4A, for managing the relationship between the store transporter 411 and the provided service 412. The attribute information table 430 is the table, shown in FIG. 4C, for managing the relationship among the store visitor ID 421, the attribute information 422, and the like.

The storage 550 also stores a video acquisition module 551, a store visitor information generation module 552, an environment information analysis module 553, and a service decision module 554.

The video acquisition module 551 is a module that acquires a video of the outside of the store, that has been captured by the outside-the-store camera 210. The store visitor information analysis module 552 is a module that extracts the store visitor 220 from the acquired video of the outside of the store, and analyzes store visitor information. The environment information analysis module 553 is a module that analyzes, from the video of the outside of the store, environment information around the store 240, that includes the weather when the store visitor 220 visits the store. The service decision module 554 is a module that decides, based on the store visitor information, the attribute information, and the environment information, a service to be provided to the store visitor 220. These modules 551 to 554 are read out into the application execution area 548 of the RAM 540 by the CPU 510, and executed. A control program 555 is a program that controls the overall information processing apparatus 200.

The input/output interface 560 interfaces input/output data with an input/output device. The input/output interface 560 is connected to a display unit 561 and an operation unit 562. The input/output interface 560 may also be connected to a storage medium 564. Furthermore, a loudspeaker 563 serving as a voice output unit, a microphone serving as a voice input unit, or a GPS position determiner may be connected. Note that programs and data that are associated with the general-purpose functions of the information processing apparatus 200 and other feasible functions are not shown in the RAM 540 or the storage 550 of FIG. 5.

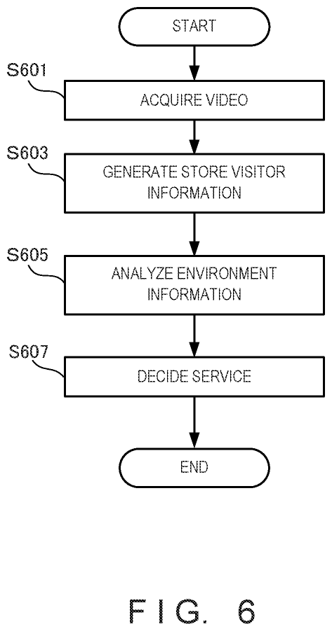

FIG. 6 is a flowchart for explaining the processing procedure of the information processing apparatus 200 according to this example embodiment. This flowchart is executed by the CPU 510 of FIG. 5 using the RAM 540, thereby implementing the functional components of the information processing apparatus 200 shown in FIG. 3.

In step S601, the video acquirer 301 of the information processing apparatus 200 acquires a video of the outside of the store 240, that has been captured by the outside-the-store camera 210. In step S603, the store visitor information generator 302 of the information processing apparatus 200 extracts the store visitor 220 to the store 240 from the acquired video, and analyzes store visitor information. In step S605, the environment information analyzer 303 of the information processing apparatus 200 analyzes, from the acquired video, environment information around the store 240, that includes the weather when the store visitor 220 visits the store 240. In step S607, the service decider 304 of the information processing apparatus 200 decides, based on the analyzed store visitor information and environment information, a service to be provided to the store visitor 220.

According to this example embodiment, since a provided service is decided in accordance with the analysis result of store visitor information, it is possible to provide an effective service to the store visitor. Furthermore, since a service to be provided to a store visitor is decided based on store visitor information and environment information, it is possible to provide a more effective service to the store visitor.

### Third Example Embodiment

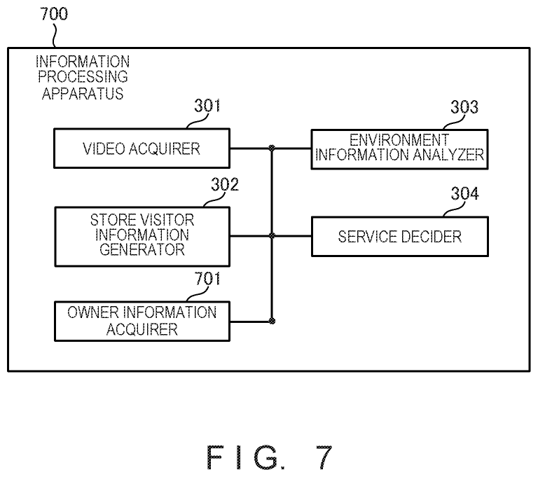

An information processing apparatus according to the third example embodiment of the present invention will be described next with reference to FIGS. 7 to 10. FIG. 7 is a block diagram showing the arrangement of an information processing apparatus according to this example embodiment. An information processing apparatus 700 according to this example embodiment is different from that in the second example embodiment in that an owner information acquirer is included. The remaining components and operations are the same as those in the second example embodiment. Hence, the same reference numerals denote the same components and operations, and a detailed description thereof will be omitted.

The information processing apparatus 700 includes an owner information acquirer 701. If a store transporter 230 of a store visitor 220 is an automobile (car) or a motorcycle (motorbike), the owner information acquirer 701 acquires owner information of the automobile or the motorcycle from a video captured by an outside-the-store camera 210. The owner information acquirer 701 reads the automobile registration number of the license plate of the automobile or the motorcycle from the video. Then, the information processing apparatus 700 acquires, from a database or the like, information of the owner of the automobile or the motorcycle and the like using the read automobile registration number as a key.

A service decider 304 decides a service to be provided to the store visitor 220 in accordance with the acquired owner information.

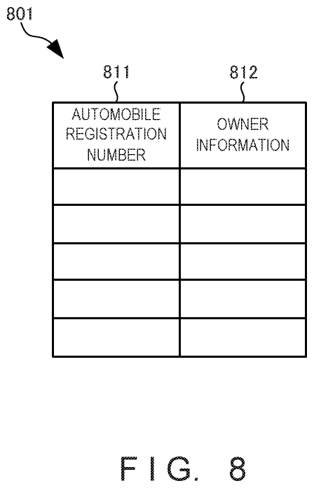

FIG. 8 is a table showing an example of an owner information table 801 included in the information processing apparatus 700 according to this example embodiment. The owner information table 801 stores owner information 812 in association with an automobile registration number 811. For example, the owner information acquirer 701 acquires the owner information with reference to the owner information table 801.

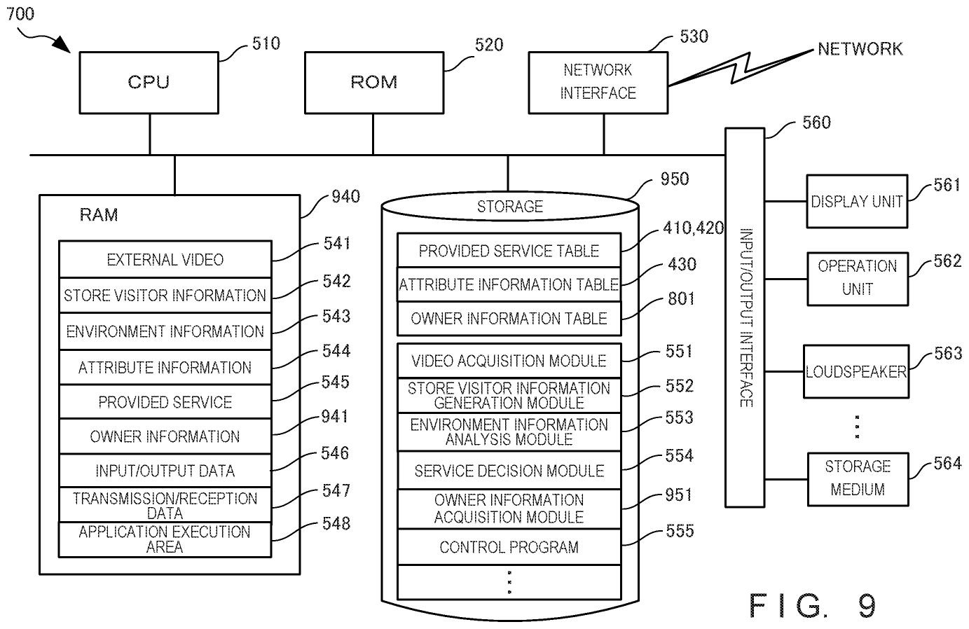

FIG. 9 is a block diagram showing the hardware arrangement of the information processing apparatus 700 according to this example embodiment. A RAM 940 is a random access memory used as a temporary storage work area by a CPU 510. An area to store data necessary for implementation of this example embodiment is allocated to the RAM 940. Owner information 941 is information about the owner of an automobile or a motorcycle when the store transporter 230 of the store visitor 220 is the automobile or the motorcycle.

A storage 950 stores the owner information table 801. The owner information table 801 is the table, shown in FIG. 8, for managing the relationship between the automobile registration number 811 and the owner information 812.

The storage 950 also stores an owner information acquisition module 951. The owner information acquisition module 951 is a module that acquires, when the store transporter 230 of the store visitor 220 is an automobile or a motorcycle, owner information of the automobile or the motorcycle from a video. The owner information acquisition module 951 is read out into an application execution area 548 of the RAM 940 by the CPU 510, and executed.

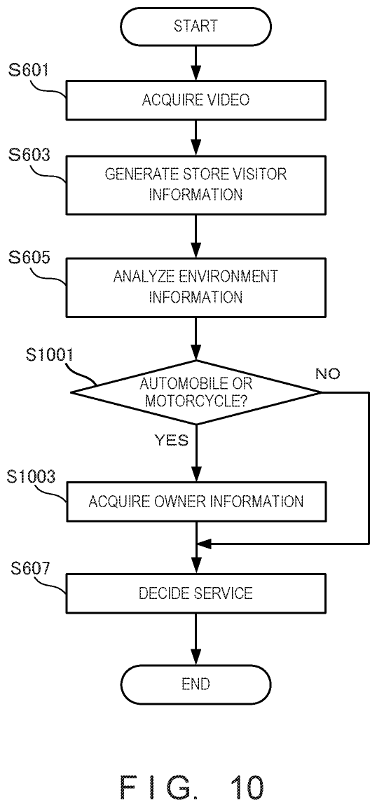

FIG. 10 is a flowchart for explaining the processing procedure of the information processing apparatus 700 according to this example embodiment. This flowchart is executed by the CPU 510 of FIG. 9 using the RAM 940, thereby implementing the functional components of the information processing apparatus 700 shown in FIG. 7.

In step S1001, the information processing apparatus 700 determines whether the store transporter 230 of the store visitor 220 is a car or a motorbike. If the store transporter 230 of the store visitor 220 is neither a car nor a motorbike (NO in step S1001), the information processing apparatus 700 advances to step S607.

If the store transporter 230 of the store visitor 220 is an automobile or a motorcycle (YES in step S1001), the information processing apparatus 700 advances to step S1003. In step S1003, the information processing apparatus 700 acquires owner information of the automobile or the motorcycle from the video captured by the outside-the-store camera 210.

According to this example embodiment, since a provided service is decided in accordance with the analysis result of store visitor information, it is possible to provide an effective service to a store visitor. Furthermore, since a service to be provided to a store visitor is decided based on store visitor information and environment information, it is possible to provide a more effective service to the store visitor. In addition, a more effective high-quality service according to a store transporter can be provided to a store visitor who uses an automobile or a motorcycle.

### Fourth Example Embodiment

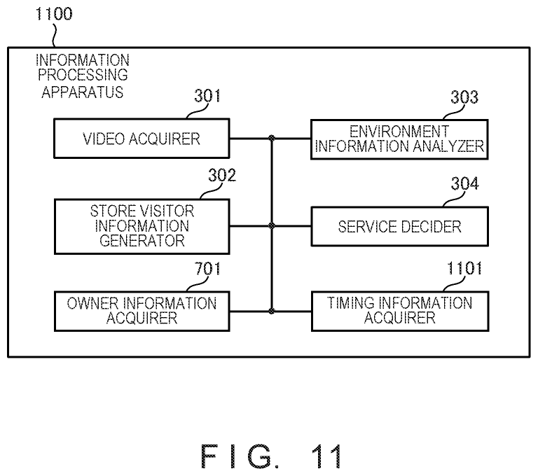

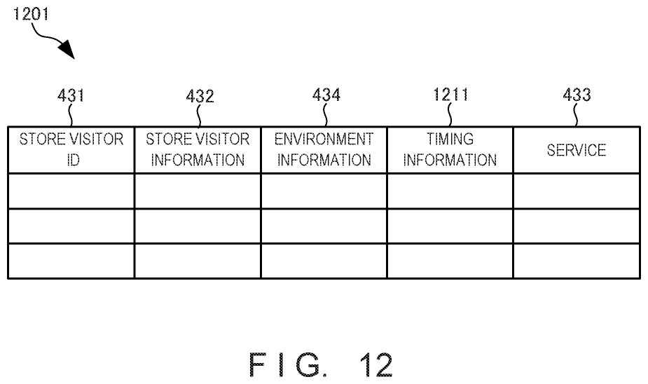

An information processing apparatus according to the fourth example embodiment of the present invention will be described next with reference to FIGS. 11 and 12. FIG. 11 is a block diagram showing the arrangement of an information processing apparatus according to this example embodiment. An information processing apparatus 1100 according to this example embodiment is different from those in the second and third example embodiments in that a timing information acquirer is included. The remaining components and operations are the same as those in the second example embodiment. Hence, the same reference numerals denote the same components and operations, and a detailed description thereof will be omitted.

The information processing apparatus 1100 further includes a timing information acquirer 1101. The timing information acquirer 1101 acquires timing information when a store visitor 220 visits a store 240. The timing information is, for example, information about the store visit date/time or store visit time, the store visit time period, the store visit month, the store visit date, the store visit day, and the store visit season of the store visitor 220. The present invention, however, is not limited to them. A service decider 304 decides a service to be provided to the store visitor 220 by additionally considering the timing information.

FIG. 12 is a table showing an example of a timing information table 1201 included in the information processing apparatus 1100 according to this example embodiment. The timing information table 1201 stores timing information 1211 in association with a store visitor ID 431. Then, the information processing apparatus 1100 decides a service to be provided to a store visitor with reference to the timing information table 1201. Note that a service to be provided to the operator of the store or the like other than the store visitor may be decided in accordance with the timing information.

According to this example embodiment, since a service to be provided is decided in consideration of timing information obtained when a store visitor visits a store, it is possible to provide a more effective high-quality service according to the timing.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. An information processing apparatus comprising:
at least one memory configured to store instructions; and
at least one processor configured to execute the instructions to;
generate store visitor information of a store visitor who visits a store by analyzing a video acquired from at least one image capturer that captures an outside of the store; and
decides, based on the generated store visitor information, a service to be provided to the store visitor.

2. The information processing apparatus according to claim 1, wherein the store visitor information comprises at least one of attribute information of the store visitor, store transporter information of the store visitor, pre/post-visit behavior information, and store visit member information.

3. The information processing apparatus according to claim 2, wherein the attribute information comprises at least one of an age, a sex, and a physique of the store visitor.

4. The information processing apparatus according to claim 1, wherein the processor is configured to execute to;
stores, in association with each other, the store visitor information and a store visitor video extracted from the video; and
generates the store visitor information.

5. The information processing apparatus according to claim 1, wherein the processor is configured to execute to;
analyze environment information around the store in the case where the store visitor visits the store,
decide the service to be provided to the store visitor by additionally considering the environment information.

6. The information processing apparatus according to claim 1, wherein the processor is configured to execute to;
decide the service to be provided to the store visitor by additionally considering timing information obtained when the store visitor visits the store.

7. The information processing apparatus according to claim 1, wherein the processor is configured to execute to;
decide, as the service, at least one of a service to be used while the store visitor visits the store, a service for prompting the store visitor to visit the store again, and a service for promoting a store visit, to the store, of a customer other than the store visitor.

8. The information processing apparatus according to claim 2, wherein the processor is configured to execute to;
acquires, if the store transporter information indicates one of an automobile and a motorcycle, owner information of the corresponding one of the automobile and the motorcycle from the video; and
decide the service to be provided to the store visitor in accordance with the owner information.

9. An information processing method comprising:
generating store visitor information of a store visitor who visits a store by analyzing a video acquired from at least one image capturer that captures an outside of the store; and
deciding, based on the store visitor information generated in the generating, a service to be provided to the store visitor.

10. A non-transitory computer readable storage medium storing an information processing program for causing a computer to execute a method, comprising:
generating store visitor information of a store visitor who visits a store by analyzing a video acquired from at least one image capturer that captures an outside of the store; and
deciding, based on the store visitor information generated in the generating, a service to be provided to the store visitor.

11. The information processing apparatus according to claim 2, wherein the processor is configured to execute to;
store, in association with each other, the store visitor information and a store visitor video extracted from the video; and
generate the store visitor information.

12. The information processing apparatus according to claim 3, wherein the processor is configured to execute to;
store, in association with each other, the store visitor information and a store visitor video extracted from the video; and
generate the store visitor information.

13. The information processing apparatus according to claim 2, wherein the processor is configured to execute to;
analyze environment information around the store in the case where the store visitor visits the store,
decide the service to be provided to the store visitor by additionally considering the environment information.

14. The information processing apparatus according to claim 3, wherein the processor is configured to execute to;
analyze environment information around the store in the case where the store visitor visits the store,
decide the service to be provided to the store visitor by additionally considering the environment information.

15. The information processing apparatus according to claim 4, wherein the processor is configured to execute to;
analyze environment information around the store in the case where the store visitor visits the store,
decide the service to be provided to the store visitor by additionally considering the environment information.

16. The information processing apparatus according to claim 2, wherein the processor is configured to execute to;
decide the service to be provided to the store visitor by additionally considering timing information obtained when the store visitor visits the store.

17. The information processing apparatus according to claim 3, wherein the processor is configured to execute to;
decide the service to be provided to the store visitor by additionally considering timing information obtained when the store visitor visits the store.

18. The information processing apparatus according to claim 4, wherein the processor is configured to execute to;
decide the service to be provided to the store visitor by additionally considering timing information obtained when the store visitor visits the store.

19. The information processing apparatus according to claim 5, wherein the processor is configured to execute to;
decide the service to be provided to the store visitor by additionally considering timing information obtained when the store visitor visits the store.

20. The information processing apparatus according to claim 3, wherein the processor is configured to execute to;
acquire, if the store transporter information indicates one of an automobile and a motorcycle, owner information of the corresponding one of the automobile and the motorcycle from the video; and
decide the service to be provided to the store visitor in accordance with the owner information.
